(19) United States
(12) Patent Application Publication
(10) Pub. No.: US 2010/0199865 A1
(43) Pub. Date: Aug. 12, 2010

(54) CAP PRINTING DEVICE

(75) Inventor: Roger L. JENNINGS, Glens Falls, NY (US)

Correspondence Address: NIXON & VANDERHYE, PC, 901 NORTH GLEBE ROAD, 11TH FLOOR, ARLINGTON, VA, 22203, US

(73) Assignee: R JENNINGS MANUFACTURING COMPANY, INC., South Glens Falls, NY (US)

(21) Appl. No.: 12/689,774

(22) Filed: Jan. 19, 2010

Related U.S. Application Data
(60) Provisional application No. 61/151,632, filed on Feb. 11, 2009.

(51) Int. Cl. B05C 17/08; B41M 1/12

(52) U.S. Cl. 101/126; 101/129

(57) ABSTRACT

A screen cap printing device has a saddle secured to a frame for mounting a cap for printing. The saddle has a flat platen which supports the front panel of the cap so that the peak of the cap lays flat on the platen. The saddle also includes side forming members used to position the cap with a registration plate that engages the bill of the cap. The saddle and the registration plate triangulate the positioning of the cap prior to printing and maintain the cap in position during printing. The registration plate is secured to the frame in a spaced-apart perpendicular relationship to the platen and defines a channel between the platen and the side forming members for receiving the sweatband of the cap. Adhesive may be provided on the platen to hold the cap in place and hold the front panel of the cap in position while printing. Also connected to the frame is a screen in a screen frame which is adapted to move between an advanced position wherein the screen contacts the front panel of the cap which is mounted upon the saddle and a retracted position wherein the screen is withdrawn for changing caps. The screen printing device may be used to print on caps of the fused buckram type and may be used to prints such as three dimensional images and four color process images.

### CROSS-REFERENCES TO RELATED APPLICATIONS

This application claims the benefit of U.S. Application 61/151,632, filed Feb. 11, 2009, the entire contents of which are incorporated herein by reference.

### FIELD OF THE INVENTION

This invention relates to cap printers which use a silk screen for transferring a design to the front panel of a cap.

### BACKGROUND OF THE INVENTION

Logos and various designs have been applied to the front panel of caps for many years. The original way of applying these logos or designs was by making a patch and then sewing the patch to the front of the cap. This process, however, proved to be quite time consuming and expensive and has been substantially replaced by two methods presently in use.

One of these methods involves a heat transfer process and the use of appliqués. This process, and its drawbacks, are discussed in my previous U.S. Pat. No. Re 32,731. For the reasons discussed in that patent, a number of printers began using a process commonly known as silk-screen printing.

With silk screen printing, the printer first stretches a mono-filament mesh over a frame to create a screen. To assure that there is no distortion when printing, the tension must be the same on all parts of the screen. The mesh is then coated with a photosensitive liquid or dry film called emulsion or capillary film, respectively. The image to be printed is dense black on clear media that is laid over the photosensitive material. UV light “exposes,” that is, converts to a water resistant status all the photosensitive material, except where the light was blocked by the dense black image. The photosensitive material that was covered by the black image is then washed out with water so ink can be printed through the screen using a tool called a squeegee. Inks can dry by evaporation or require heat to melt the plastic binder to pigment into the fabric.

Several of the advantages of screen printing include the speed with which a screen can be prepared, generally by the printer, and that the screen may be available for follow-up orders. Also, by using silk screens, printers have successfully avoided the difficulties of having the design crack or peel as occurred with appliques. For these reasons, the use of silk screen printing has been widely accepted. However, when applied to the printing of caps, a number of difficulties were encountered which prevented cap printers from taking full advantage of the silk screen process. Some of the difficulties unique to cap printing include trying to print onto a normally rounded surface and mounting all the caps in the same position so that the caps and the silk screen are properly aligned thereby avoiding crooked or off-centered impressions. This alignment is commonly referred to as registration.

When one prints onto the rounded front panel of a cap using a flat silk screen, a distorted impression is obtained. This is due to the cap material and screen not being parallel and the tension on the material being uneven. These variations cause the image to appear distorted when the material returns to its natural shape.

In an attempt to overcome this shortcoming, several approaches were used. The first used a curved silk screen which matches the curvature of the cap being printed upon. The second approach used a flat platen and attempted to flatten the curved front panel of the cap. Neither of these approaches were successfully implemented and there was, and still is, a need for an accurate and clear printing silk screen cap printer.

U.S. Pat. No. Re 32,731 discloses my previous approach to silk screen printing onto the front panel of a cap. In the silk screen cap printing device of U.S. Pat. No. Re 32,731, when the cap was mounted upon the printer, the tension across the front panel would be fairly equal at all points. Second, the screen and the cap would be aligned in the same way for each printing. Third, the normally curved surface of the cap would be converted to a flat surface suitable for printing. Fourth, the cap would be mounted onto the printer in such a way that it would not move during printing. The silk screen cap printing device of U.S. Pat. No. Re 32,731 achieved these results by “blocking” the cap during printing, i.e. by providing interior supports at specific areas within the cap to avoid creasing and stretching of the fabric which would interfere with the flatness of the front panel of the cap being printed on and cause distortion in the image. Tension applied against the three bottom edges of the saddle set against the tension of the front panel of the cap on the flat platen of the saddle served to block the cap and produce distortion free printed images.

The silk screen cap printing device of U.S. Pat. No. Re 32,731 proved to be successful in printing on caps described by suppliers as “foam front, mesh back” caps. These caps are commonly referred to as “trucker caps” and include a front panel that is formed of a foam material that stretches easily. The silk screen cap printing device of U.S. Pat. No. Re 32,371 proved to be successful also in printing on caps described by suppliers as “unstructured” or “unconstructed” or “flexible front” caps. These terms are synonymous. Further, the device is successful with “5 panel” versions of these caps where there is one panel of flexible material for printing and with “6 panel” versions of these caps where two panels of flexible material are sewn together forming a vertical line down the center image area.

In more recent years, a new cap construction called a “fused buckram” or “structured” or “constructed” cap has become popular. The fused buckram caps have stiff front panels that do not stretch like the foam front panels of trucker caps and unstructured caps. Fused buckram caps thus do not require blocking during printing. Furthermore, the stiff front panels are curved and do not conform to the flat print surface of the printing device of U.S. Pat. No. Re 32,731. The peak of the fused buckram cap, which is the highest point of the print area, stands above the platen preventing the screen from making contact with the cap during the print stroke. The front panel of the fused buckram cap, which is sewn to the bill in a curved shape, also does not make contact with the flat printing surface.

Previous attempts to silk screen print on fused buckram caps have included providing a curved platen rather than a flat platen. Fused buckram caps are made in different sizes and shapes. Curved platens of various sizes and shapes are used to position the caps. No bill support was provided. The curved platen was matched to the curvature of the cap. Each cap and platen combination is different from other combinations, but the curvature of the screen does not change. The cap and platen are not parallel to the screen. Distortion of the image results.

In practice, curved screens have no tension in the mesh. The mesh shifts from the friction of the squeegee. Ink smears across the bottom of the screen and must be cleaned off after several prints in order to have sharp, clean prints. Also, the shifting mesh can result in the image printing in a different position with each print stroke and colors intended to align, or register, with each other can be out of alignment, or registration. The use of curved platens has come with a recommendation of printing with the mesh of the screen being in contact with the cap so that the cap will help prevent the mesh from shifting. This “on contact” approach to printing contrasts with “off contact” printing that is an industry standard for all other forms of printing, for example shirts. Off contact printing is followed so that the ink can release cleanly from the screen. On contact printing results in ink being picked up from the image by the mesh which is laying in the ink. The printed image may not be opaque and may lack color strength. The ink that is picked up by the mesh requires cleaning the bottoms of the screens after several prints.

Printing over a curved surface requires the squeegee angle to change during the print stroke. The angle of the squeegee to the screen determines how much ink is deflected down through the image and onto the cap. When the angle of the squeegee changes, the amount of ink deposited on the cap changes. An industry standard practice is to print with a constant angle between the squeegee and the screen so that the ink deposit is uniform.

The drawbacks of curved platen printing devices has resulted in most screen printing companies to abandon the curved platen printing devices and now only offer embroidered caps, or to decline the opportunity to provide caps. Embroidery is now the dominant method of decorating caps. Those companies that do still print with curved platen printing devices typically offer only one color prints, and do not offer more technical prints like three dimensional images and four color process images that are available for caps that are not the fused buckram variety.

### SUMMARY OF THE INVENTION

An aspect of the invention is a cap printing device that maintains the front panel of a fused buckram cap flat so that there are parallel printing surfaces.

Another aspect of the invention is a cap printing device wherein each cap, when mounted, has the same aligned relationship with the silk screen.

A further aspect of the invention is a cap printing device that secures the cap and thereby avoids movement during printing.

Yet another aspect of the invention is a cap printing device wherein the design being transferred is not distorted and the design is also being centered in the same position on each cap.

A still further aspect of the invention is a cap printing device that is able to meet the technical requirements of butt registered colors, three dimensional images and four color process.

According to a sample embodiment, a cap printing device for screen printing onto the front panel of a cap of the type having a sweatband and a bill comprises a frame; a saddle secured to the frame for mounting the cap for printing, the saddle comprising a flat platen and a pair of side panels extending from opposite ends of the flat platen; a registration plate secured to the frame in a spaced-apart perpendicular relationship with the platen, the space between the registration plate and the platen defining a channel for receiving the sweatband of the cap; and means for movably securing a screen to the frame for movement between an advanced position wherein the screen contacts the front panel of a cap mounted on the saddle and a retracted position wherein the screen is withdrawn for changing caps, wherein the side panels and the registration plate position the cap when the screen is in the retracted position so that the flat platen of the saddle supports the front panel of the cap such that a peak of the cap lays flat on the flat platen when the screen is in the advanced position.

According to another sample embodiment, a cap printing device for screen printing onto a non-stretchable front panel of a cap of the type having a sweatband and a bill comprises a U-shaped frame comprising a base and first and second vertical extensions; a saddle secured to the first vertical extension for mounting the cap for printing, the saddle comprising a flat platen and a pair of side panels extending from opposite ends of the flat platen; a registration plate secured to the first vertical extension in a spaced-apart perpendicular relationship with the platen, the space between the registration plate and the platen defining a channel for receiving the sweatband of the cap; and a screen frame holder configured to support a screen frame for movement between an advanced position wherein the screen contacts the front panel of a cap mounted on the saddle and a retracted position wherein the screen is withdrawn for changing caps, the screen frame holder being secured to the second vertical extension of the frame, the screen frame holder comprising an L-shaped platform comprising a base attached to the second vertical extension and an upright extending perpendicularly upward from the base, the screen frame holder also comprising at least one clamp attached to the base by a hinge, the hinge being pivotable to move the screen frame between the advanced and retracted position, the screen frame holder further comprising at least one spring connected between the L-shaped platform and the at least one clamp to bias the screen frame holder into the retracted position, wherein the side panels and the registration plate position the cap when the screen is in the retracted position so that the flat platen of the saddle supports the front panel of the cap such that a peak of the cap lays flat on the flat platen when the screen is in the advanced position.

According to another sample embodiment, a method of screen printing onto the front panel of a cap having a bill and a sweatband comprises mounting the cap on a saddle having a pair of side panels for positioning a front panel of the cap over a flat platen of the saddle for supporting the front panel of the cap so that its sweatband overhangs the platen; pressing the bill of the cap against a registration plate positioned in a spaced-apart perpendicular relationship with the platen; pressing the front panel of the cap to secure the front panel using adhesive on the flat platen of the saddle; and screen printing on the front panel of the cap.

### BRIEF DESCRIPTION OF THE DRAWINGS

Sample embodiments will be described in relation to the following drawings, in which like reference numbers denote like features, wherein:

FIG. 1 is a rear perspective view of a sample embodiment of a cap printing device;

FIG. 2 is a side elevation view of the cap printing device of FIG. 1;

FIG. 3 is a side elevation view of the cap printing device of FIG. 1 showing a cap mounted upon the saddle and a silk screen applied for printing;

FIG. 4 is an enlargement of several of the interacting components of FIG. 3; and

FIG. 5 is a rear end view taken along lines 5-5 of FIG. 2.

### DETAILED DESCRIPTION OF ILLUSTRATED EMBODIMENTS

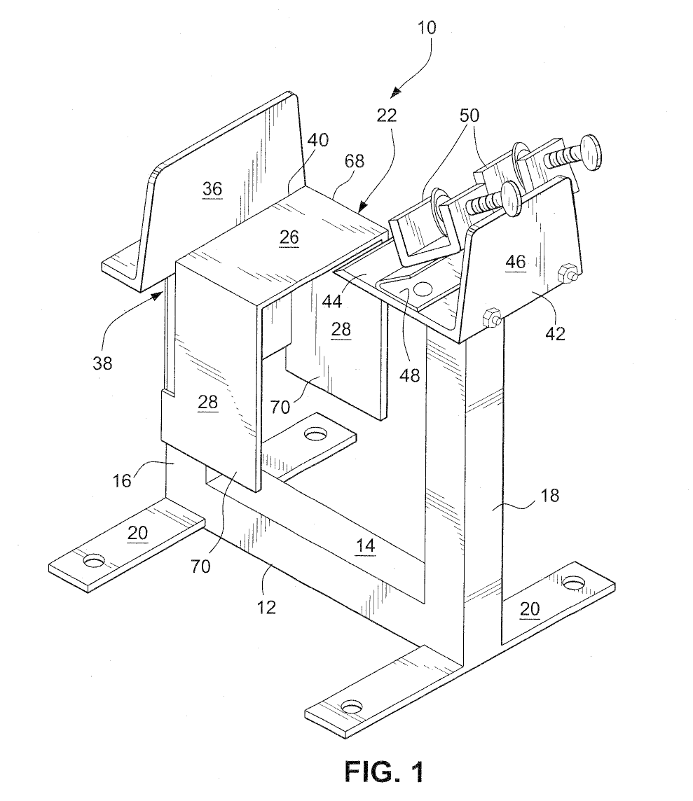

FIG. 1 schematically illustrates a sample embodiment of the cap printing device, or printer, 10. The cap printer 10 has a frame 12 which is generally U-shaped. The frame 12 comprises a crossbar 14 which would correspond to the base of the U, a first vertical extension 16 and a second vertical extension 18. A pair of legs 20 extend outwardly from the crossbar 14 and are perpendicular to the vertical extensions 16, 18 for supporting the frame 12. For the purposes of this description, the first vertical extension 16 is considered to be the front of the printer 10 and the second vertical extension 18 is considered to be the rear of the printer 10.

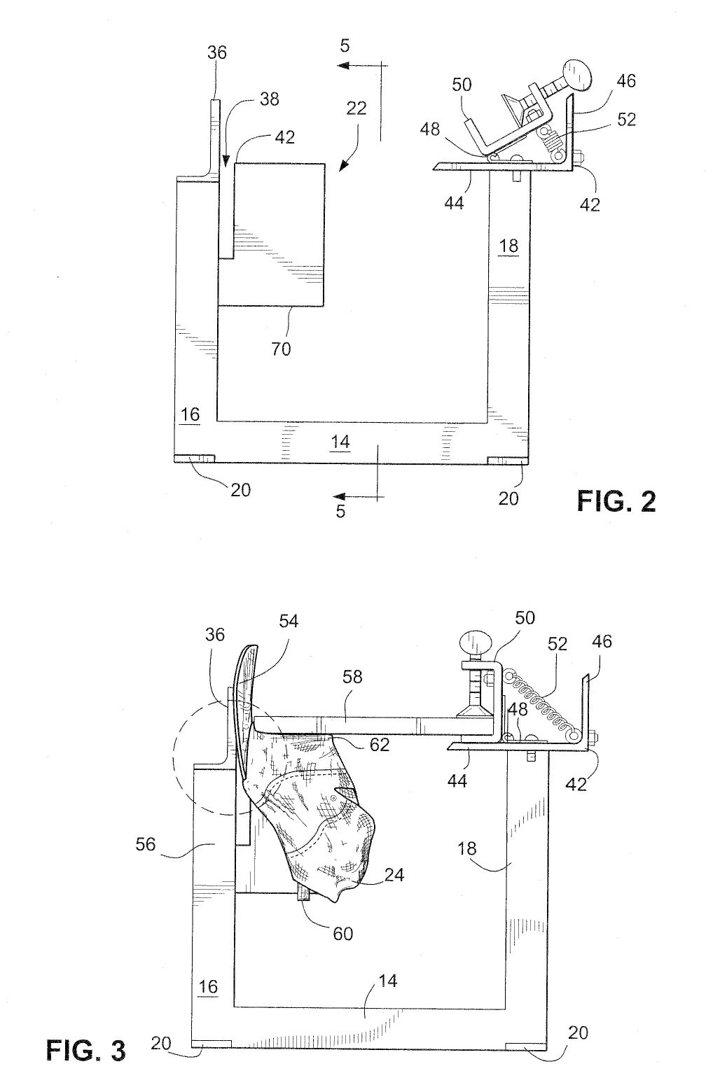

Mounted upon the first vertical extension 16 and extending toward the second vertical extension 18 is a saddle 22 for mounting a cap 24, as shown in FIG. 3. The saddle 22 is inverted U-shaped having a flat platen 26 as the base of the U and two side panels, or side forming members, 28 extending downwardly therefrom. The side forming members 28 and flat platen 26 may include rounded side edges 68 (FIG. 5). The side panels 28 terminate in bottom edges 70. The space between the rear edge of one side panel 28 to the rear edge of the other side panel 28 is open, as shown in FIG. 1.

Attached to the top of the first vertical extension 16 is a registration plate 36. The base of the registration plate 36 is slightly below the platen 26. The registration plate 36 is substantially perpendicular to the platen 26 and rises above the platen 26. The registration plate 36 and the platen 26 are secured in a spaced-apart relationship to each other such that a channel 38 exists between the plate 26 and the front edge 40 of the platen 26. The registration plate 36 serves to triangulate the positioning of the cap 24 (FIG. 3) as described in more detail below.

Mounted atop the second vertical extension 18 is an L-shaped platform 42. The L-shaped platform 42 has a base 44 which is attached to the second vertical extension 18 and an upright 46 extending perpendicularly upward from the base 44 and attached to the rearmost portion of the base 44. Mounted upon the base 44 of the platform 42 is a hinge 48 and mounted to the hinge 48 are two clamps 50. The clamps move between an advanced position (FIG. 3) and a retracted position (FIG. 2). The base 44 extends forwardly of the hinge 48 so that when the clamps 50 move to the advanced position, they will contact the forward portion of the base 44 thereby preventing excess movement beyond the advanced position. In the advanced position, the clamps 50 are substantially perpendicular to the base 44. Bolted to each clamp 50 is a spring 52. Each spring 52 is also bolted to the platform 42 and serves to bias the clamp 50 to its retracted position.

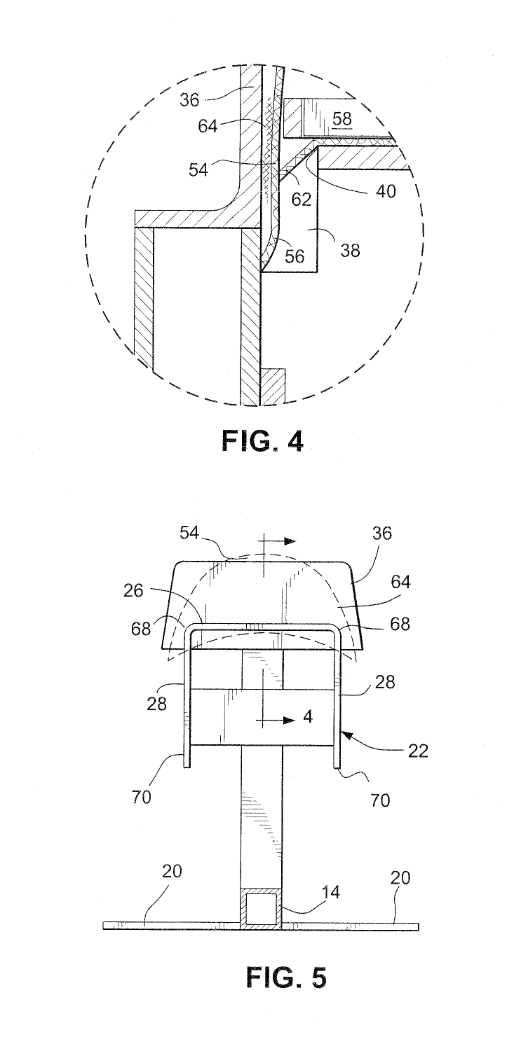

As shown in FIGS. 3 and 4, a cap 24, for example of the fused buckram type, is placed over the saddle 22 and is moved forwardly until the bill 54 comes in contact with the registration plate 36. The cap 24 may be adjustable, for example by an adjustment band 60 provided at the back of the cap 24. The front panel 62 of the cap rests upon the flat platen 26. In addition, the sweatband 56 is folded out so that it enters the channel 38. When the cap 24 is mounted in this manner, a screen (not shown) placed within a screen frame 58 which is, in turn, secured in clamps 50, will move to its advanced position which corresponds to the advanced position of the clamps 50 such that the screen presses upon the front panel 62 of the cap 24.

FIG. 4 schematically illustrates the interrelationship between the registration plate 36, the flat platen 26 and the channel 38 when a cap 24 is mounted for printing. As shown in FIG. 4, part of the front panel 62 of the cap 24 is drawn downwardly into the channel 38. Also positioned in the channel is the sweatband 56 and a portion of the bill 54 of the cap 24. When in position, the portions of the bill 54 and sweatband 56 through which the cross section was taken are slightly rearward of the registration plate 36. Shown pressing against the registration plate 36 is the underside of the outward end 64 of the bill 54 (FIG. 5). Once the cap 24 is triangulated, the front panel 62 of the cap 24 is pressed down onto the platen 26 into adhesive (not shown) that has been applied to the flat surface. The adhesive holds the cap 24 in place. The triangulation is the registration plate 36 in one dimension, and a visual sighting of the crease formed in the cap 24 at the edges 68 compared to the seam in the cap 24 where the front panel 62 of the cap 24 is sewn to the sides of the cap 24. The dimension on each side must be the same to have the cap 24 triangulated. When the screen frame 58 is moved to its advanced position, the front part of the frame contacts the bill and pushes it slightly toward the registration plate 36. Since the bill 54 of most caps is not flat, but rather is somewhat raised in the middle where contacted by the frame 58, this creates a small but useful pressure between the frame 58 and the bill 54 and between the side edges 64 of the bill and registration plate 36. The pressures thus created help to secure and stabilize the cap during the printing step which follows. The printing comprises running an ink squeegee over the screen, thereby transferring the desired image to the cap.

The placement of the bill 54 against the registration plate 36 results in virtually the same registration for each cap placed upon the saddle 22. The flat platen 26 of the saddle 22 may be smaller than the flat platen of the saddle of my previous U.S. Pat. No. Re 32,731. For example, the flat platen of the saddle of my previous U.S. Pat. No. Re 32,371 had a width of about 5¼ inches, whereas the flat platen 26 of the saddle 22 of the sample embodiment disclosed herein may be, for example about 3¾ inches. This smaller flat platen allows the front panel 62 of a fused buckram cap 24, which does not stretch, to lie flat on the smaller print surface of the saddle.

The side forming members 28 of the saddle 22 of the sample embodiment disclosed herein may also be smaller than the side forming members of my previous U.S. Pat. No. Re 32,731. This is because the side forming members are used for positioning the cap in combination with the bill support (i.e. registration plate 36) rather than blocking a fabric that stretches. The beveled edges and retention bar of the saddle of my previous U.S. Pat. No. Re 32,371 have also been eliminated because the shape of a fused buckram cap cannot be changed, and the function of the saddle is not to provide a supporting shape similar to the crown of a cap. Instead, the bill support (registration plate) in combination with the saddle serves only to triangulate the positioning of the fused buckram cap prior to printing.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A cap printing device for screen printing onto a non-stretchable front panel of a cap of the type having a sweatband and a bill, comprising:
a frame;
a saddle secured to the frame for mounting the cap for printing, the saddle comprising a flat platen and a pair of side panels extending from opposite ends of the flat platen;
a registration plate secured to the frame in a spaced-apart perpendicular relationship with the platen, the space between the registration plate and the platen defining a channel for receiving the sweatband of the cap; and
means for movably securing a screen to the frame for movement between an advanced position wherein the screen contacts the front panel of a cap mounted on the saddle and a retracted position wherein the screen is withdrawn for changing caps, wherein the side panels and the registration plate position the cap when the screen is in the retracted position so that the flat platen of the saddle supports the front panel of the cap such that a peak of the cap lays flat on the flat platen when the screen is in the advanced position.

2. A cap printing device according to claim 1, further comprising means for biasing the screen to its retracted position.

3. A cap printing device according to claim 1, wherein the means for movably securing the screen to the frame comprises at least one clamp.

4. A cap printing device according to claim 1, wherein the frame is U-shaped.

5. A cap printing device according to claim 1, wherein the flat platen and side panels comprise front and rear edges, and the space defined between the rear edges is open.

6. A cap printing device according to claim 1, wherein the frame further comprises a pair of legs.

7. A cap printing device according to claim 1, wherein adhesive is applied to the flat platen to hold the front panel of the cap when the screen is in the advanced position.

8. A cap printing device according to claim 1, wherein a width of the flat platen is about 3¾ inches.

9. A cap printing device for screen printing onto a non-stretchable front panel of a cap of the type having a sweatband and a bill, comprising:
a U-shaped frame comprising a base and first and second vertical extensions;
a saddle secured to the first vertical extension for mounting the cap for printing, the saddle comprising a flat platen and a pair of side panels extending from opposite ends of the flat platen;
a registration plate secured to the first vertical extension in a spaced-apart perpendicular relationship with the platen, the space between the registration plate and the platen defining a channel for receiving the sweatband of the cap; and
a screen frame holder configured to support a screen frame for movement between an advanced position wherein the screen contacts the front panel of a cap mounted on the saddle and a retracted position wherein the screen is withdrawn for changing caps, the screen frame holder being secured to the second vertical extension of the frame, the screen frame holder comprising an L-shaped platform comprising a base attached to the second vertical extension and an upright extending perpendicularly upward from the base, the screen frame holder also comprising at least one clamp attached to the base by a hinge, the hinge being pivotable to move the screen frame between the advanced and retracted position, the screen frame holder further comprising at least one spring connected between the L-shaped platform and the at least one clamp to bias the screen frame holder into the retracted position, wherein the side panels and the registration plate position the cap when the screen is in the retracted position so that the flat platen of the saddle supports the front panel of the cap such that a peak of the cap lays flat on the flat platen when the screen is in the advanced position.

10. A method of screen printing onto a non-stretchable front panel of a cap having a bill and a sweatband, the method comprising:
mounting the cap on a saddle having a pair of side panels for positioning a front panel of the cap over a flat platen of the saddle for supporting the front panel of the cap so that its sweatband overhangs the platen;
pressing the bill of the cap against a registration plate positioned in a spaced-apart perpendicular relationship with the platen;
pressing the front panel of the cap to secure the front panel using adhesive on the flat platen of the saddle; and
screen printing on the front panel of the cap.

11. A method according to claim 10, wherein screen printing comprises printing a three dimensional image.

12. A method according to claim 10, wherein screen printing comprises printing a four color image.
